(19) United States
(12) Patent Application Publication
(10) Pub. No.: US 2016/0198140 A1
(43) Pub. Date: Jul. 7, 2016

(54) SYSTEM AND METHOD FOR PREEMPTIVE AND ADAPTIVE 360 DEGREE IMMERSIVE VIDEO STREAMING

(71) Applicant: 3doo, Inc., New York, NY (US)

(72) Inventor: Ingo Nadler, Bad Breisig (DE)

(73) Assignee: 3doo, Inc., New York, NY (US)

(21) Appl. No.: 14/590,267

(22) Filed: Jan. 6, 2015

(51) Int. Cl. H04N 13/00; H04N 21/218; G06F 3/01; G06F 17/30; H04N 21/81; H04N 13/04

(52) U.S. Cl. CPC H04N 13/0059; H04N 21/816; H04N 13/0468; H04N 13/0048; G06F 3/012; G06F 3/013; G06F 17/30781; H04N 21/21805; H04N 2013/0081

(57) ABSTRACT

A method for delivering streaming 3D video to an electronic device is presented, the method including storing scene files including unwrapped hemispherical representations of scenes for left and right eye perspective views in first and second video files, respectively. The method includes transmitting the scene files of the left and right eye perspective views to the electronic having head tracking capabilities, 3D video streaming capabilities, and 3D viewing capabilities into the electronic device. The method also includes allowing the electronic device to request from the one or more servers the left and right eye perspective views including the scene files having the unwrapped hemispherical representations of scenes for the left and right eye perspective views, extracting and re-coding the requested left and right eye perspective views including the scene files, and enabling the electronic device to stream real-time 3D video and allowing 360 degree freedom of eye movement for the user.

### BACKGROUND

1. Technical Field

The present disclosure relates to immersive video streaming. More particularly, the present disclosure relates to a system and method for delivering 360 degree immersive video streaming to an electronic device and for allowing a user of the electronic device to seamlessly change viewing directions when viewing 3D data/information.

2. Description of Related Art

As the processing power of microprocessors and the quality of graphics systems have increased, environment mapping systems have become feasible on consumer electronic systems. Environment mapping systems use computer graphics to display the surroundings or environment of a theoretical viewer. Ideally, a user of the environment mapping system can view the environment at any horizontal or vertical angle. Conventional environment mapping systems include an environment capture system and an environment display system. The environment capture system creates an environment map which contains the necessary data to recreate the environment of a viewer. The environment display system displays portions of the environment in a view window based on the field of view of the user of the environment display system.

Computer systems, through different modeling techniques, attempt to provide a virtual environment to system users. Despite advances in computing power and rendering techniques permitting multi-faceted polygonal representation of objects and three-dimensional interaction with the objects, users remain wanting a more realistic experience. Thus, a computer system may display an object in a rendered environment, in which a user may look in various directions while viewing the object in a 3D environment or on a 3D display screen. However, the level of detail is dependent on the processing power of the user's computer as each polygon must be separately computed for distance from the user and rendered in accordance with lighting and other options. Even with a computer with significant processing power, one is left with the unmistakable feeling that one is viewing a non-real environment.

Immersive videos are moving pictures that in some sense surround a user and allows the user to “look” around at the content of the picture. Ideally, a user of the immersive system can view the environment at any angle or elevation. A display system shows part of the environment map as defined by the user or relative to azimuth and elevation of the view selected by the user. Immersive videos can be created using environment mapping, which involves capturing the surroundings or environment of a theoretical viewer and rendering those surroundings into an environment map.

Current implementations of immersive video involve proprietary display systems running on specialized machines. These proprietary display systems inhibit compatibility between different immersive video formats. Furthermore, the use of specialized machines inhibits portability of different immersive video formats. Types of specialized machines include video game systems with advanced display systems and high end computers having large amounts of random access memory (RAM) and fast processors.

Therefore, what is needed is a method and system capable of smoothly delivering immersive video to one or more electronic devices by allowing the user of the electronic device to change his/her viewing direction, thus enabling complete freedom of movement for the user to look around the scene of a 3D image or 3D video or 3D environment.

### SUMMARY

Embodiments of the present disclosure are described in detail with reference to the drawing figures wherein like reference numerals identify similar or identical elements.

An aspect of the present disclosure provides a method for delivering streaming 3D video to an electronic device. The method includes the steps of storing first scene files including unwrapped hemispherical representations of scenes for a left eye perspective view in a first video file located in one or more servers; storing second scene files including unwrapped hemispherical representations of scenes for a right eye perspective view in a second video file located in the one or more servers; transmitting the first and second scene files of the left and right eye perspective views, respectively, to the electronic device from the one or more servers, the electronic device having head tracking capabilities, 3D video streaming capabilities, and 3D viewing capabilities; generating, via the electronic device, left and right eye perspective views of a user; detecting, via the electronic device, a head position and a head movement of the user; allowing the electronic device to request from the one or more servers the left and right eye perspective views including the first and second scene files having the unwrapped hemispherical representations of scenes for the left and right eye perspective views, respectively; extracting and re-encoding the requested left and right eye perspective views including the first and second scene files having the unwrapped hemispherical representations of scenes for the left and right eye perspective views, respectively; and enabling the electronic device to stream real-time 3D video with 360 degree freedom of eye motion for the user by switching between bandwidths based on the extracted and re-encoded left and right eye perspective views including the first and second scene files having the unwrapped hemispherical representations of scenes.

In one aspect, the electronic device includes display hardware.

In another aspect, the electronic device is one of a wearable electronic device, a gaming console, a mobile device, and a 3D television.

In yet another aspect, the electronic device includes a client application for predicting the eye motion of the user of the electronic device by calculating a probability graph.

In one aspect, the probability graph is calculated by generating a first vector for each frame of the first and second video files of the unwrapped hemispherical representations of scenes for the left and right eye perspective views, respectively; selecting two consecutive frames and generating a second vector therefrom including a direction of motion of the eyes of the user; storing the second vector in a time-coded file for each frame of the two consecutive frames; and transmitting motion vector data to the client application of the electronic device of the user.

In another aspect, if a disparity map of the first and second video files is available, a change in disparity between the two consecutive frames is included in calculating the probability graph.

In yet another aspect, the motion vector data is used for the switching between the bandwidths to enable the 360 degree freedom of the eye motion for the user.

An aspect of the present disclosure provides a method for delivering streaming 3D video to an electronic device. The method includes the steps of storing first scene files including unwrapped hemispherical representations of scenes for a left eye perspective view in a first video file located in one or more servers; storing second scene files including unwrapped hemispherical representations of scenes for a right eye perspective view in a second video file located in the one or more servers; transmitting the first and second scene files of the left and right eye perspective views, respectively, to the electronic device from the one or more servers, the electronic device having head tracking capabilities, 3D video streaming capabilities, and 3D viewing capabilities; generating, via the electronic device, left and right eye perspective views of a user; detecting, via the electronic device, a head position and a head movement of the user; allowing the electronic device to request from the one or more servers the left and right eye perspective views including the first and second scene files having the unwrapped hemispherical representations of scenes for the left and right eye perspective views, respectively; extracting the requested left and right eye perspective views including the first and second scene files having the unwrapped hemispherical representations of scenes for the left and right eye perspective views, respectively; merging the extracted left and right eye perspective views including the first and second scene files having the unwrapped hemispherical representations of scenes for the left and right eye perspective views, respectively, into a stereoscopic side-by-side format; re-encoding the merged left and right eye perspective views; and enabling the electronic device to stream real-time 3D video with 360 degree freedom of eye motion for the user by switching between bandwidths based on the extracted and re-encoded left and right eye perspective views including the first and second scene files having the unwrapped hemispherical representations of scenes.

Another aspect of the present disclosure provides a system for delivering streaming 3D video. The system includes one or more servers for storing scene files including unwrapped hemispherical representations of scenes for a left eye perspective view and a right eye perspective view; a network connected to the one or more servers; an electronic device in communication with the network, the electronic device having head tracking capabilities, 3D video streaming capabilities, and 3D viewing capabilities, the electronic device configured to request from the one or more servers the left and right eye perspective views including the scene files having the unwrapped hemispherical representations of scenes for the left and right eye perspective views; a calculating module for calculating a probability graph for predicting eye motion of a user of the electronic device; an extracting module and a re-encoding module for extracting and re-encoding the requested left and right eye perspective views including the scene files having the unwrapped hemispherical representations of scenes for the left and right eye perspective views; wherein the electronic device streams real-time 3D video with 360 degree freedom of eye motion for the user by switching between bandwidths based on the probability graph calculated.

Certain embodiments of the present disclosure may include some, all, or none of the above advantages and/or one or more other advantages readily apparent to those skilled in the art from the drawings, descriptions, and claims included herein. Moreover, while specific advantages have been enumerated above, the various embodiments of the present disclosure may include all, some, or none of the enumerated advantages and/or other advantages not specifically enumerated above.

### BRIEF DESCRIPTION OF THE DRAWING

Various embodiments of the present disclosure are described herein below with references to the drawings, wherein:

FIG. 1 is a flowchart illustrating a process for streaming immersive video in 360 degrees in an agnostic content delivery network (CDN), in accordance with embodiments of the present disclosure;

FIG. 2 is a flowchart illustrating a process for predicting where a user will look next to avoid interruptions in the immersive video streaming, in accordance with embodiments of the present disclosure;

FIG. 3 is a flowchart illustrating a process for calculating a probability graph, in accordance with embodiments of the present disclosure;

FIG. 4 is a flowchart illustrating a process for merging extracted left and right eye perspective views into a stereoscopic side-by-side format, in accordance with embodiments of the present disclosure;

FIG. 5 is a flowchart illustrating a process for streaming immersive video in 360 degrees in modified content delivery network (CDN) software, in accordance with embodiments of the present disclosure; and

FIG. 6 is a system depicting streaming immersive video in 360 degrees onto an electronic device of a user, in accordance with embodiments of the present disclosure.

The figures depict embodiments of the present disclosure for purposes of illustration only. One skilled in the art will readily recognize from the following disclosure that alternative embodiments of the structures and methods illustrated herein may be employed without departing from the principles of the present disclosure described herein.

### DETAILED DESCRIPTION

Although the present disclosure will be described in terms of specific embodiments, it will be readily apparent to those skilled in this art that various modifications, rearrangements and substitutions may be made without departing from the spirit of the present disclosure. The scope of the present disclosure is defined by the claims appended hereto.

For the purposes of promoting an understanding of the principles of the present disclosure, reference will now be made to the exemplary embodiments illustrated in the drawings, and specific language will be used to describe the same. It will nevertheless be understood that no limitation of the scope of the present disclosure is thereby intended. Any alterations and further modifications of the inventive features illustrated herein, and any additional applications of the principles of the present disclosure as illustrated herein, which would occur to one skilled in the relevant art and having possession of this disclosure, are to be considered within the scope of the present disclosure.

The word “exemplary” is used herein to mean “serving as an example, instance, or illustration.” Any embodiment described herein as “exemplary” is not necessarily to be construed as preferred or advantageous over other embodiments. The word “example” may be used interchangeably with the term “exemplary.”

The term “electronic device” may refer to one or more personal computers (PCs), a standalone printer, a standalone scanner, a mobile phone, an MP3 player, gaming consoles, audio electronics, video electronics, GPS systems, televisions, recording and/or reproducing media (such as CDs, DVDs, camcorders, cameras, etc.) or any other type of consumer or non-consumer analog and/or digital electronics. Such consumer and/or non-consumer electronics may apply in any type of entertainment, communications, home, and/or office capacity. Thus, the term “electronic device” may refer to any type of electronics suitable for use with a circuit board and intended to be used by a plurality of individuals for a variety of purposes. The electronic device may be any type of computing and/or processing device.

The term “processing” may refer to determining the elements or essential features or functions or processes of one or more 3D systems for computational processing. The term “process” may further refer to tracking data and/or collecting data and/or manipulating data and/or examining data and/or updating data on a real-time basis in an automatic manner and/or a selective manner and/or manual manner.

The term “analyze” may refer to determining the elements or essential features or functions or processes of one or more 3D systems for computational processing. The term “analyze” may further refer to tracking data and/or collecting data and/or manipulating data and/or examining data and/or updating data on a real-time basis in an automatic manner and/or a selective manner and/or manual manner.

The term “storage” may refer to data storage. “Data storage” may refer to any article or material (e.g., a hard disk) from which information may be capable of being reproduced, with or without the aid of any other article or device. “Data storage” may refer to the holding of data in an electromagnetic form for access by a computer processor. Primary storage may be data in random access memory (RAM) and other “built-in” devices. Secondary storage may be data on hard disk, tapes, and other external devices. “Data storage” may also refer to the permanent holding place for digital data, until purposely erased. “Storage” implies a repository that retains its content without power. “Storage” mostly means magnetic disks, magnetic tapes and optical discs (CD, DVD, etc.). “Storage” may also refer to non-volatile memory chips such as flash, Read-Only memory (ROM) and/or Electrically Erasable Programmable Read-Only Memory (EEPROM).

The term “module” or “unit” may refer to a self-contained component (unit or item) that may be used in combination with other components and/or a separate and distinct unit of hardware or software that may be used as a component in a system, such as a 3D system. The term “module” may also refer to a self-contained assembly of electronic components and circuitry, such as a stage in a computer that may be installed as a unit. The term “module” may be used interchangeably with the term “unit.”

Stereoscopic view refers to a perceived image that appears to encompass a 3-dimensional (3D) volume. To generate the stereoscopic view, a device displays two images on a 2-dimensional (2D) area of a display. These two images include substantially similar content, but with slight displacement along the horizontal axis of one or more corresponding pixels in the two images. The simultaneous viewing of these two images, on a 2D area, causes a viewer to perceive an image that is popped out of or pushed into the 2D display that is displaying the two images. In this way, although the two images are displayed on the 2D area of the display, the viewer perceives an image that appears to encompass the 3D volume.

The two images of the stereoscopic view are referred to as a left-eye image and a right-eye image, respectively. The left-eye image is viewable by the left eye of the viewer, and the right-eye image is not viewable by the left eye of the viewer. Similarly, the right-eye image is viewable by the right eye of the viewer, and the left-eye image is not viewable by the right eye of the viewer. For example, the viewer may wear specialized glasses, where the left lens of the glasses blocks the right-eye image and passes the left-eye image, and the right lens of the glasses blocks the left-eye image and passes the right-eye image.

Because the left-eye and right-eye images include substantially similar content with slight displacement along the horizontal axis, but are not simultaneously viewable by both eyes of the viewer (e.g., because of the specialized glasses), the brain of the viewer resolves the slight displacement between corresponding pixels by commingling the two images. The commingling causes the viewer to perceive the two images as an image with 3D volume.

Three-dimensional (3D) cameras, such as stereo cameras or multi-view cameras, generally capture left and right images using two or more cameras functioning similarly to human eyes, and cause a viewer to feel a stereoscopic effect due to disparities between the two images. Specifically, a user observes parallax due to the disparity between the two images captured by a 3D camera, and this binocular parallax causes the user to experience a stereoscopic effect.

When a user views a 3D image, the binocular parallax which the user sees can be divided into (a) negative parallax, (b) positive parallax, and (c) zero parallax. Negative parallax means objects appear to project from a screen, and positive parallax means objects appear to be behind the screen. Zero parallax refers to the situation where objects appear to be on the same horizontal plane as the screen.

In 3D images, negative parallax generally has a greater stereoscopic effect than positive parallax, but has a greater convergence angle than positive parallax, so viewing positive parallax is more comforting to the human eyes. However, if objects in 3D images have only positive parallax, eyes feel fatigue even though eyes feel comfortable in the positive parallax. In the same manner, if objects in 3D images have only negative parallax, both eyes feel fatigue.

Parallax refers to the separation of the left and right images on the display screen. Motion parallax refers to objects moving relative to each other when one's head moves. When an observer moves, the apparent relative motion of several stationary objects against a background gives hints about their relative distance. If information about the direction and velocity of movement is known, motion parallax can provide absolute depth information.

Regarding immersive viewing in 360 degrees, our visual system with which we explore our real world has two characteristics not often employed together when engaging with a virtual world. The first is the 3D depth perception that arises from the two different images our visual cortex receives from our horizontally offset eyes. The second is our peripheral vision that gives us visual information up to almost 180 degrees horizontally and 120 degrees vertically. While each of these is often exploited individually, there have been few attempts to engage both. Recently, hemispherical domes have been employed to take advantage of both characteristics.

A hemispherical dome with the user at the center is an environment where the virtual world occupies the entire visual field of view. A hemispherical surface has advantages over multiple planar surfaces that might surround the viewer. The hemispherical surface (without corners) can more readily become invisible. This is a powerful effect in a dome where even without explicit stereoscopic projection the user often experiences a 3D sensation due to motion cues. Hemispherical optical projection systems are used to project images onto the inner surfaces of domes. Such systems are used in planetariums, flight simulators, and in various hemispherical theaters. With the present interest in virtual reality and three-dimensional rendering of images, hemispherical optical projection systems are being investigated for projecting images which simulate a real and hemispherical environment. Typically, hemispherical dome-shaped optical projection systems include relatively large domes having diameters from about 4 meters to more than 30 meters. Such systems are well suited for displays to large audiences. Immersive virtual environments have many applications in such fields as simulation, visualization, and space design. A goal of many of these systems is to provide the viewer with a full sphere (180°×360°) of image or a hemispherical image (90°×360°).

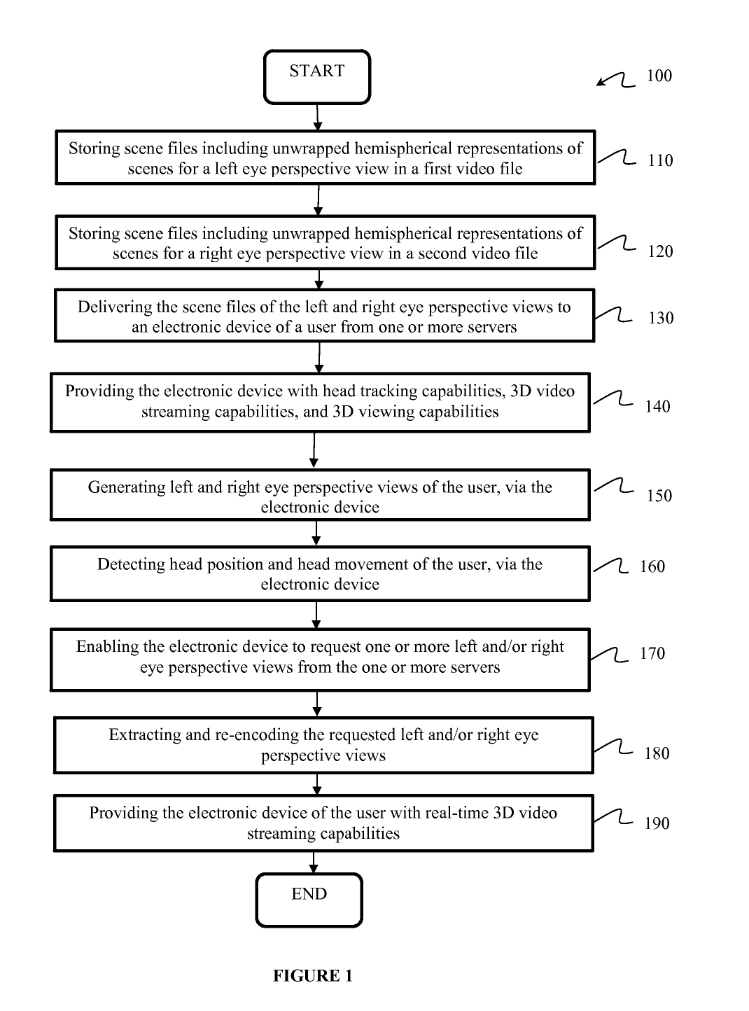

FIG. 1 a flowchart illustrating a process for streaming immersive video in 360 degrees in an agnostic content delivery network (CDN), in accordance with embodiments of the present disclosure.

The flowchart 100 includes the following steps. In step 110, scene files including unwrapped hemispherical representations of scenes for a left eye perspective view are stored in a first video file. In step 120, scene files including unwrapped hemispherical representations of scenes for a right eye perspective view are stored in a second video file. In step 130, the scene files of the left and right eye perspective views are delivered to an electronic device of a user from one or more servers used for storing the first and second video files. In step 140, the electronic device is provided with head tracking capabilities, 3D video streaming capabilities, and 3D viewing capabilities. In step 150, the electronic device generates left and right eye perspective views of the user. In step 160, the electronic device detects a head position and a head movement of the user. In step 170, the electronic device requests one or more left and/or right perspective views including unwrapped hemispherical representations of scenes for the left and/or right eye perspective views, respectively, that are stored in the first and second video files, respectively, stored on the one or more servers. In step 180, the left and/or right perspective views including unwrapped hemispherical representations of scenes are extracted and re-encoded. In step 190, the electronic device of the user is provided with real-time 3D video streaming capabilities by switching between bandwidths based on the extracted and re-encoded left and right eye perspective views including the first and second scene files having the unwrapped hemispherical representations of scenes. The process then ends.

It is to be understood that the method steps described herein need not necessarily be performed in the order as described. Further, words such as “thereafter,” “then,” “next,” etc., are not intended to limit the order of the steps. These words are simply used to guide the reader through the description of the method steps.

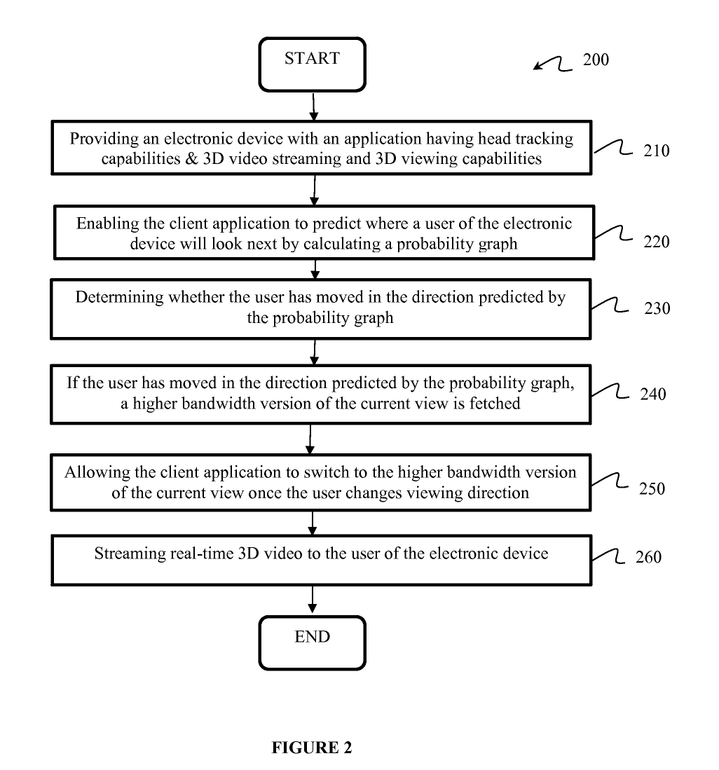

FIG. 2 is a flowchart illustrating a process for predicting where a user will look next to avoid interruptions in the immersive video streaming, in accordance with embodiments of the present disclosure.

The flowchart 200 includes the following steps. In step 210, an electronic device is provided with an application having head tracking capabilities, 3D video streaming capabilities, and 3D viewing capabilities. In step 220, the client application predicts where a user of the electronic device will look next by calculating a probability graph. In other words, the electronic device continuously tracks, monitors, and records eye movement of the user to predict future potential eye movement. In step 230, it is determined whether the user has his/her eyes moved in the direction predicted by the probability graph. In step 240, if the user has moved his/her eyes in the direction predicted by the probability graph, a higher bandwidth version of the current view is fetched or retrieved from the one or more servers. In step 250, the client application of the electronic device of the user switches to a higher bandwidth 3D video stream of the current view once it is detected that user eye motion has changed (i.e., viewing direction has changed). In step 260, the real-time 3D video is streamed to the user of the electronic device live and in real-time. The process then ends.

It is to be understood that the method steps described herein need not necessarily be performed in the order as described. Further, words such as “thereafter,” “then,” “next,” etc., are not intended to limit the order of the steps. These words are simply used to guide the reader through the description of the method steps.

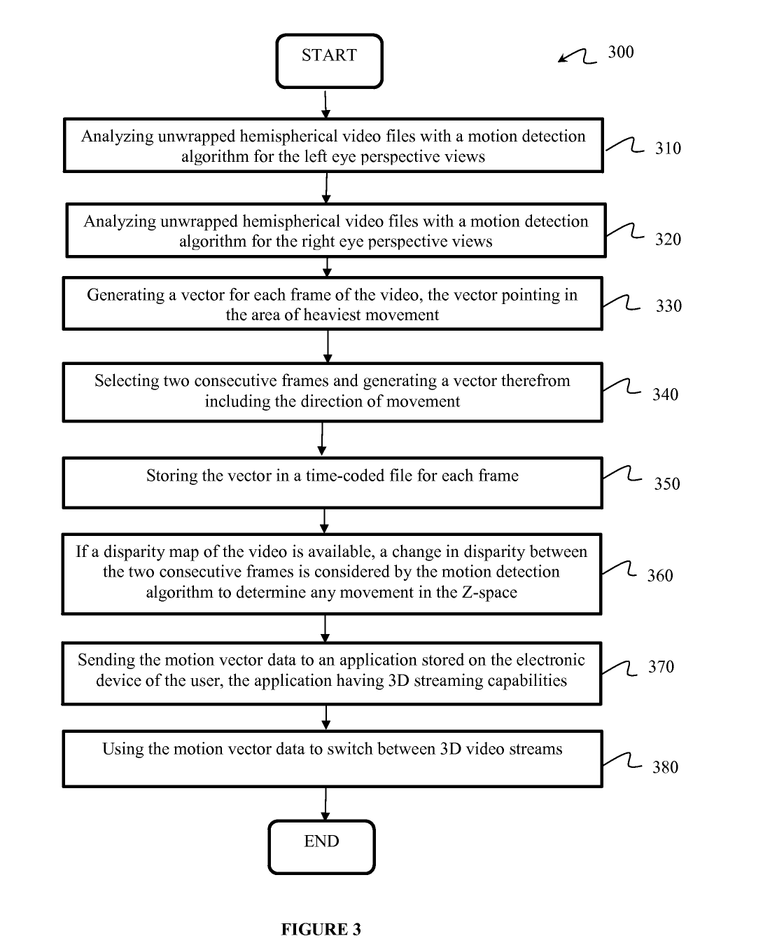

FIG. 3 is a flowchart illustrating a process for calculating a probability graph, in accordance with embodiments of the present disclosure.

The flowchart 300 includes the following steps. In step 310, the unwrapped hemispherical video files are analyzed by a motion detection algorithm for left eye perspective views. In step 320, the unwrapped hemispherical video files are analyzed by a motion detection algorithm for right eye perspective views. In step 330, a vector is generated for each frame of the first and second video files, the vectors pointing in the areas with heaviest movement. In step 340, two consecutive frames are selected and a vector is generated therefrom including the direction of movement. In step 350, the vector is stored in a time-coded file for each frame. In step 360, if a disparity map of the video is available, a change in disparity between the two consecutive frames is considered by the motion detection algorithm to determine any movement in the Z-space. In step 370, the derived motion vector data is sent to the application on the electronic device of the user. In step 380, the motion vector data is used to switch between 3D video streams or between different bandwidths of the 3D video streams. The process then ends.

It is to be understood that the method steps described herein need not necessarily be performed in the order as described. Further, words such as “thereafter,” “then,” “next,” etc., are not intended to limit the order of the steps. These words are simply used to guide the reader through the description of the method steps.

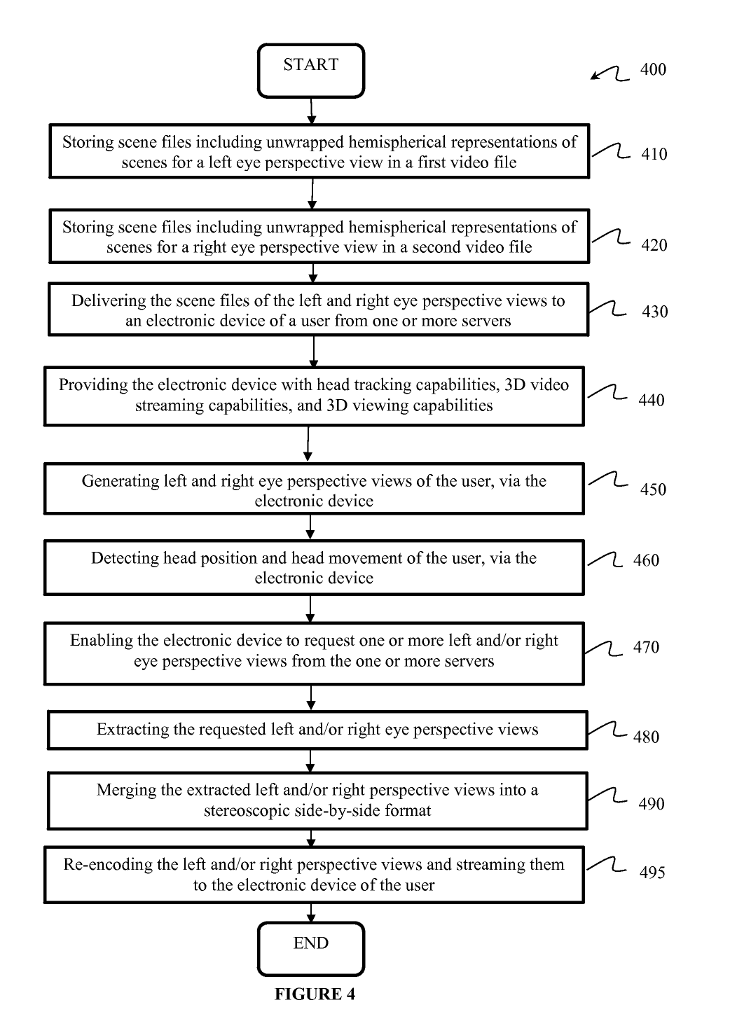

FIG. 4 is a flowchart illustrating a process for merging extracted left and right eye perspective views into a stereoscopic side-by-side format, in accordance with embodiments of the present disclosure.

The flowchart 400 includes the following steps. In step 410, scene files including unwrapped hemispherical representations of scenes for a left eye perspective view are stored in a first video file. In step 420, scene files including unwrapped hemispherical representations of scenes for a right eye perspective view are stored in a second video file. In step 430, the scene files of the left and right eye perspective views are delivered to an electronic device of a user from one or more servers used for storing the first and second video files. In step 440, the electronic device is provided with head tracking capabilities, 3D video streaming capabilities, and 3D viewing capabilities. In step 450, the electronic device generates left and right eye perspective views of the user. In step 460, the electronic device detects a head position and a head movement of the user. In step 470, the electronic device requests one or more left and/or right perspective views including unwrapped hemispherical representations of scenes for the left and/or right eye perspective views, respectively, that are stored in the first and second video files, respectively, stored on the one or more servers. In step 480, the requested left and/or right eye perspective views are extracted. In step 490, the extracted left and/or right eye perspective views are merged into a stereoscopic side-by-side format. In step 495, left and/or right eye perspective views are re-encoded and streamed to the electronic device of the user for 3D viewing. The process then ends.

It is to be understood that the method steps described herein need not necessarily be performed in the order as described. Further, words such as “thereafter,” “then,” “next,” etc., are not intended to limit the order of the steps. These words are simply used to guide the reader through the description of the method steps.

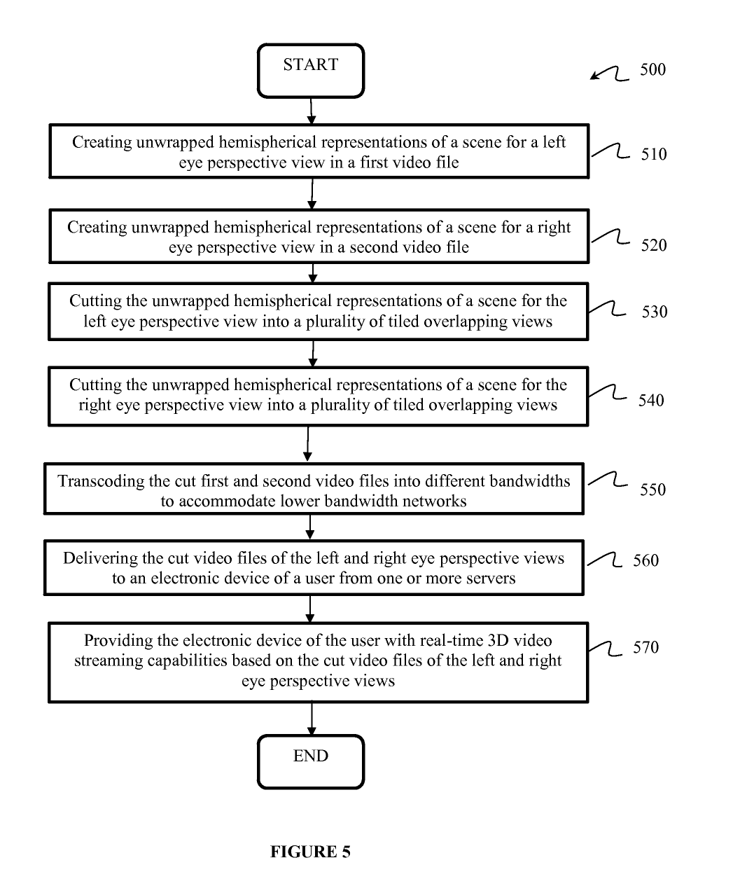

FIG. 5 is a flowchart illustrating a process for streaming immersive video in 360 degrees in modified content delivery network (CDN) software, in accordance with embodiments of the present disclosure.

The flowchart 500 includes the following steps. In step 510, an unwrapped hemispherical representation of a scene for a left eye perspective view is created in a first video file. In step 520, an unwrapped hemispherical representation of a scene for a right eye perspective view is created in a second video file. In step 530, the unwrapped hemispherical representation of a scene for a left eye perspective view is cut into a plurality of tiled overlapping views. In step 540, the unwrapped hemispherical representation of a scene for a right eye perspective view is cut into a plurality of tiled overlapping views. In step 550, the cut first and second video files are transcoded into different bandwidths to accommodate lower bandwidth networks. In step 560, the cut video files of the left and right eye perspective views are delivered to the electronic device of the user from the one or more servers. In step 570, the electronic device of the user is provided with real-time 3D streaming capabilities based on the cut video files of the left and right eye perspective views. The process then ends.

It is to be understood that the method steps described herein need not necessarily be performed in the order as described. Further, words such as “thereafter,” “then,” “next,” etc., are not intended to limit the order of the steps. These words are simply used to guide the reader through the description of the method steps.

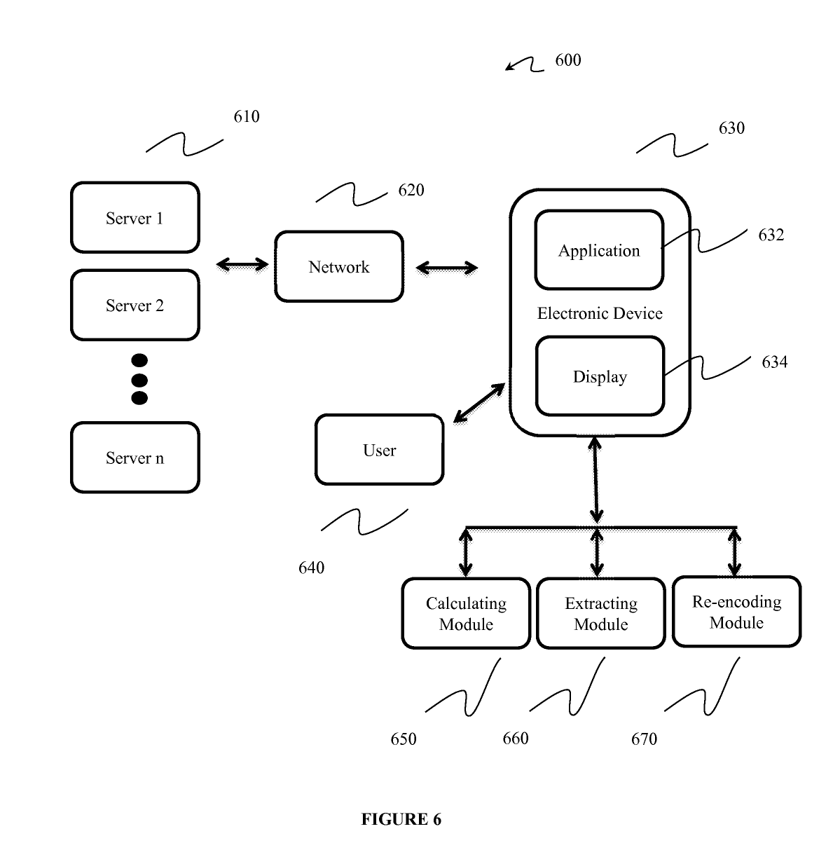

FIG. 6 is a system depicting streaming immersive video in 360 degrees onto an electronic device of a user, in accordance with embodiments of the present disclosure.

System 600 includes one or more servers 610 in electrical communication with a network 620. An electronic device 630 of a user 640 is in electrical communication with the one or more servers 610 via the network 620. The electronic device 630 includes an application 632, as well as display hardware 634. The electronic device 630 may be in communication with at least a calculating module 650, an extracting module 660, and a re-encoding module 670.

Network 620 may be a group of interconnected (via cable and/or wireless) computers, databases, servers, routers, and/or peripherals that are capable of sharing software and hardware resources between many users. The Internet is a global network of networks. Network 620 may be a communications network. Thus, network 620 may be a system that enables users of data communications lines to exchange information over long distances by connecting with each other through a system of routers, servers, switches, databases, and the like.

Network 620 may include a plurality of communication channels. The communication channels refer either to a physical transmission medium such as a wire or to a logical connection over a multiplexed medium, such as a radio channel. A channel is used to convey an information signal, for example a digital bit stream, from one or several senders (or transmitters) to one or several receivers. A channel has a certain capacity for transmitting information, often measured by its bandwidth. Communicating data from one location to another requires some form of pathway or medium. These pathways, called communication channels, use two types of media: cable (twisted-pair wire, cable, and fiber-optic cable) and broadcast (microwave, satellite, radio, and infrared). Cable or wire line media use physical wires of cables to transmit data and information. The communication channels are part of network 620.

Moreover, the electronic device 630 may be a computing device, a wearable computing device, a smartphone, a smart watch, a gaming console, or a 3D television. Of course, one skilled in the art may contemplate any type of electronic device capable of streaming 3D data/information. The application 632 may be embedded within the electronic device 630. However, one skilled in the art may contemplate the application 632 to be separate and distinct from the electronic device 630. The application 632 may be remotely located with respect to the electronic device 630.

In operation, the application 632 associated with the electronic device 630 sends a request to the one or more servers 610. The request is for left and right eye perspective views stored on the one or more servers 610. For example, the left eye perspective views may be stored in a first video file of one server 610, whereas the right eye perspective views may be stored in a second video file of another server 610. These stored left and right eye perspective views are unwrapped hemispherical representations of scenes. After the request has been placed, the one or more servers 610 send the predefined or predetermined unwrapped hemispherical representations of scenes for the left and right eye perspective views via the network 620 to the application 632 associated with the electronic device 630. The one or more servers 610 extract and re-encode the stored video files requested (i.e., one or more desired views) and send them to the electronic device 630 in a live 3D streaming format in order to be viewed in real-time on the electronic device 630 in 3D. As a result of this configuration, only the resolution of the target electronic device 630 has to be encoded and streamed through the network 630, thus reducing bandwidth requirements.

In an alternative embodiment, the extracted left and right eye perspective views are merged into a stereoscopic side-by-side view format and then re-encoded and streamed to the electronic device 630, thus reducing the bandwidth requirements even further.

Both of these embodiments relate to the agnostic CDN configuration.

In a further alternative embodiment, relating to the modified CDN software server configuration, the unwrapped hemispherical video files are each cut into a plurality of tiled overlapping views, thus creating, for example, 6×3=18 files per hemisphere with each view covering a field of view of 30 degrees horizontally and 30 degrees vertically. Additionally, these files may be transcoded into different bandwidths to accommodate lower bandwidth networks. In an example, with 3 different bandwidths, one eye view's hemisphere would be represented by 3×18=54 video files stored on one or more servers. An immersive media presentation (IMP) file would be stored with the video files and include the streaming location of each of the view directions and bandwidth versions foe lookup by the application 632 associated with the electronic device 630. Thus, if the application 632 would require a view covering an area from 60 to 90 degrees horizontally and a 30 degree inclination at 1 kbit bandwidth, it would look it up in the IMP file and then stream the corresponding video file.

In summary, in the exemplary embodiments of the present disclosure, the application 632 associated with the electronic device 630 predicts, with a high probability, where the user 640 will look next (eye motion detection) within the 3D environment to avoid interruptions in the 3D streaming video. A probability graph is calculated in order to determine where the user 640 will likely look next. The probability graph is determined by motion vector data. The motion vector data is fed to the application 632 associated with the electronic device 630. The motion vector data is used to request neighboring views in a lower bandwidth format and then switch between video streams seamlessly as soon as the viewer actually changes his/her direction of view. Typically, if the current frame's motion vector predicts a movement up, the application 632 would initiate streaming the view above the current view, as well as to the left and right of it. In an alternative embodiment, the application 632 may not switch between views, but may instead stream the current view and the predicted view in a lower bandwidth version. The application 632 may then use the 3D functionality of the electronic device 630 to blend the current view with the predicted view. Once the viewer has completed the view move, the application 632 discontinuous streaming the previous view and switches the current view to a higher bandwidth version in order to increase resolution and quality of 3D streaming.

The motion vector data may be calculated as follows. The unwrapped hemispheric video files are analyzed by a motion detection algorithm for the left and right eye perspective views. For each frame of the video file, a first vector is generated pointing to the area of heaviest movement. Subsequently, two consecutive frames are considered and a second vector is generated including the direction of movement. The second vector is stored in a time-coded file for each frame of the two consecutive frames. If a disparity map of the video files is available, the motion detection algorithm also considers the change in disparity between the frames and therefore determines if the movement is toward the viewer/user 640 in the Z-space. Vectors with movement toward the user 640 will always override those with general movement and will be stored. Thus, the motion vector data is computed and forwarded to the application 632 of the electronic device 630.

In summary, the exemplary embodiments of the present disclosure relate to seamless switching between bandwidths or seamless switching between 3D video streams. The exemplary embodiments of the present disclosure further relate to immersive 360 degree viewing of data/information with complete freedom of movement for the viewer to view or experience the entire 360 degree scene. The exemplary embodiments of the present disclosure further relate to streaming a whole 180 degree hemisphere or a whole 360 degree dome by meeting network bandwidth limitations. The exemplary embodiments of the present disclosure further relate to a system and method for smoothly delivering streaming immersive video to one or more electronic devices by allowing the viewer to view the entire 360 degree spectrum/environment, as viewer direction constantly changes within the 360 degree spectrum/environment. In one exemplary embodiment, the system is an agnostic CDN system, whereas in another exemplary embodiment, the system uses modified CDN server software. Therefore, the exemplary embodiments of the present disclosure combine adaptive streaming techniques with hemispherical immersive viewing, video motion analysis, and smart preemption in order to deliver smooth 3D streaming data/information in an immersive 3D environment.

Moreover, the exemplary embodiments of the present disclosure also apply to MPEG-DASH. Dynamic Adaptive Streaming over HTTP (DASH), also known as MPEG-DASH, is an adaptive bitrate streaming technique that enables high quality streaming of media content over the Internet delivered from conventional HTTP web servers. MPEG-DASH works by breaking the content into a sequence of small HTTP-based file segments, each segment containing a short interval of playback time of a content that is potentially many hours in duration, such as a movie or the live broadcast of a sports event. The content is made available at a variety of different bit rates, i.e., alternative segments encoded at different bit rates covering aligned short intervals of play back time are made available. As the content is played back by an MPEG-DASH client, the client automatically selects from the alternatives the next segment to download and play back based on current network conditions. The client selects the segment with the highest bit rate possible that can be downloaded in time for play back without causing stalls or re-buffering events in the playback. Thus, an MPEG-DASH client can seamlessly adapt to changing network conditions, and provide high quality play back without stalls or re-buffering events. MPEG-DASH uses the previously existing HTTP web server infrastructure that is used for delivery of essentially all World Wide Web content. It allows devices such as Internet connected televisions, TV set-top boxes, desktop computers, smartphones, tablets, etc. to consume multimedia content (video, TV, radio, etc.) delivered via the Internet, coping with variable Internet receiving conditions, thanks to its adaptive streaming technology.

The exemplary embodiments of the present disclosure extend the MPEG-DASH standard by applying it to 360 degree video viewing. Thus, it is important to include the header file that points to the respective segments of the multiple left and right video file segments in multiple bandwidth versions, respectively.

The implementations described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, computers, cell phones, tablets, portable/personal digital assistants, and other devices that facilitate communication of information between end-users within a network.

The general features and aspects of the present disclosure remain generally consistent regardless of the particular purpose. Further, the features and aspects of the present disclosure may be implemented in system in any suitable fashion, e.g., via the hardware and software configuration of system or using any other suitable software, firmware, and/or hardware.

For instance, when implemented via executable instructions, various elements of the present disclosure are in essence the code defining the operations of such various elements. The executable instructions or code may be obtained from a readable medium (e.g., a hard drive media, optical media, EPROM, EEPROM, tape media, cartridge media, flash memory, ROM, memory stick, and/or the like) or communicated via a data signal from a communication medium (e.g., the Internet). In fact, readable media may include any medium that may store or transfer information.

The computer means or computing means or processing means may be operatively associated with the stereoscopic system, and is directed by software to compare the first output signal with a first control image and the second output signal with a second control image. The software further directs the computer to produce diagnostic output. Further, a means for transmitting the diagnostic output to an operator of the verification device is included. Thus, many applications of the present disclosure could be formulated. The exemplary network disclosed herein may include any system for exchanging data or transacting business, such as the Internet, an intranet, an extranet, WAN (wide area network), LAN (local area network), satellite communications, and/or the like. It is noted that the network may be implemented as other types of networks.

Additionally, “code” as used herein, or “program” as used herein, may be any plurality of binary values or any executable, interpreted or compiled code which may be used by a computer or execution device to perform a task. This code or program may be written in any one of several known computer languages. A “computer,” as used herein, may mean any device which stores, processes, routes, manipulates, or performs like operation on data. A “computer” may be incorporated within one or more transponder recognition and collection systems or servers to operate one or more processors to run the transponder recognition algorithms. Moreover, computer-executable instructions include, for example, instructions and data which cause a general purpose computer, special purpose computer, or special purpose processing device to perform a certain function or group of functions. Computer-executable instructions also include program modules that may be executed by computers in stand-alone or network environments. Generally, program modules include routines, programs, objects, components, and data structures, etc., that perform particular tasks or implement particular abstract data types.

Persons skilled in the art will understand that the devices and methods specifically described herein and illustrated in the accompanying drawings are non-limiting exemplary embodiments. The features illustrated or described in connection with one exemplary embodiment may be combined with the features of other embodiments. Such modifications and variations are intended to be included within the scope of the present disclosure.

The foregoing examples illustrate various aspects of the present disclosure and practice of the methods of the present disclosure. The examples are not intended to provide an exhaustive description of the many different embodiments of the present disclosure. Thus, although the foregoing present disclosure has been described in some detail by way of illustration and example for purposes of clarity and understanding, those of ordinary skill in the art will realize readily that many changes and modifications may be made thereto without departing form the spirit or scope of the present disclosure.

While several embodiments of the disclosure have been shown in the drawings and described in detail hereinabove, it is not intended that the disclosure be limited thereto, as it is intended that the disclosure be as broad in scope as the art will allow. Therefore, the above description and appended drawings should not be construed as limiting, but merely as exemplifications of particular embodiments. Those skilled in the art will envision other modifications within the scope and spirit of the claims appended hereto.

What is claimed is:

1. A method for delivering streaming 3D video to an electronic device, the method comprising:
storing first scene files including unwrapped hemispherical representations of scenes for a left eye perspective view in a first video file located in one or more servers;
storing second scene files including unwrapped hemispherical representations of scenes for a right eye perspective view in a second video file located in the one or more servers;
transmitting the first and second scene files of the left and right eye perspective views, respectively, to the electronic device from the one or more servers, the electronic device having head tracking capabilities, 3D video streaming capabilities, and 3D viewing capabilities;
generating, via the electronic device, left and right eye perspective views of a user;
detecting, via the electronic device, a head position and a head movement of the user;
allowing the electronic device to request from the one or more servers the left and right eye perspective views including the first and second scene files having the unwrapped hemispherical representations of scenes for the left and right eye perspective views, respectively;
extracting and re-encoding the requested left and right eye perspective views including the first and second scene files having the unwrapped hemispherical representations of scenes for the left and right eye perspective views, respectively; and
enabling the electronic device to stream real-time 3D video with 360 degree freedom of eye motion for the user by switching between bandwidths based on the extracted and re-encoded left and right eye perspective views including the first and second scene files having the unwrapped hemispherical representations of scenes.

2. The method of claim 1, wherein the electronic device includes display hardware.

3. The method of claim 1, wherein the electronic device is a wearable electronic device.

4. The method of claim 1, wherein the electronic device is a gaming console.

5. The method of claim 1, wherein the electronic device is a mobile device.

6. The method of claim 1, wherein the electronic device is a 3D television.

7. The method of claim 1, wherein the electronic device includes a client application for predicting the eye motion of the user of the electronic device by calculating a probability graph.

8. The method of claim 7, wherein the probability graph is calculated by:
generating a first vector for each frame of the first and second video files of the unwrapped hemispherical representations of scenes for the left and right eye perspective views, respectively;
selecting two consecutive frames and generating a second vector therefrom including a direction of motion of the eyes of the user;
storing the second vector in a time-coded file for each frame of the two consecutive frames; and
transmitting motion vector data to the client application of the electronic device of the user.

9. The method of claim 8, wherein if a disparity map of the first and second video files is available, a change in disparity between the two consecutive frames is included in calculating the probability graph.

10. The method of claim 8, wherein the motion vector data is used for the switching between the bandwidths to enable the 360 degree freedom of the eye motion for the user.

11. A method for delivering streaming 3D video to an electronic device, the method comprising:
storing first scene files including unwrapped hemispherical representations of scenes for a left eye perspective view in a first video file located in one or more servers;
storing second scene files including unwrapped hemispherical representations of scenes for a right eye perspective view in a second video file located in the one or more servers;
transmitting the first and second scene files of the left and right eye perspective views, respectively, to the electronic device from the one or more servers, the electronic device having head tracking capabilities, 3D video streaming capabilities, and 3D viewing capabilities;
generating, via the electronic device, left and right eye perspective views of a user;
detecting, via the electronic device, a head position and a head movement of the user;
allowing the electronic device to request from the one or more servers the left and right eye perspective views including the first and second scene files having the unwrapped hemispherical representations of scenes for the left and right eye perspective views, respectively;
extracting the requested left and right eye perspective views including the first and second scene files having the unwrapped hemispherical representations of scenes for the left and right eye perspective views, respectively;
merging the extracted left and right eye perspective views including the first and second scene files having the unwrapped hemispherical representations of scenes for the left and right eye perspective views, respectively, into a stereoscopic side-by-side format;
re-encoding the merged left and right eye perspective views; and
enabling the electronic device to stream real-time 3D video with 360 degree freedom of eye motion for the user by switching between bandwidths based on the extracted and re-encoded left and right eye perspective views including the first and second scene files having the unwrapped hemispherical representations of scenes.

12. The method of claim 11, wherein the electronic device includes display hardware.

13. The method of claim 11, wherein the electronic device is one of a wearable electronic device, a gaming console, a mobile device, and a 3D television.

14. The method of claim 11, wherein the electronic device includes a client application for predicting the eye motion of the user of the electronic device by calculating a probability graph.

15. The method of claim 14, wherein the probability graph is calculated by:
generating a first vector for each frame of the first and second video files of the unwrapped hemispherical representations of scenes for the left and right eye perspective views, respectively;
selecting two consecutive frames and generating a second vector therefrom including a direction of motion of the eyes of the user;
storing the second vector in a time-coded file for each frame of the two consecutive frames; and
transmitting motion vector data to the client application of the electronic device of the user.

16. The method of claim 15, wherein if a disparity map of the first and second video files is available, a change in disparity between the two consecutive frames is included in calculating the probability graph.

17. A system for delivering streaming 3D video, the system comprising:
one or more servers for storing scene files including unwrapped hemispherical representations of scenes for a left eye perspective view and a right eye perspective view;
a network connected to the one or more servers;
an electronic device in communication with the network, the electronic device having head tracking capabilities, 3D video streaming capabilities, and 3D viewing capabilities, the electronic device configured to request from the one or more servers the left and right eye perspective views including the scene files having the unwrapped hemispherical representations of scenes for the left and right eye perspective views;
a calculating module for calculating a probability graph for predicting eye motion of a user of the electronic device;
an extracting module and a re-encoding module for extracting and re-encoding the requested left and right eye perspective views including the scene files having the unwrapped hemispherical representations of scenes for the left and right eye perspective views;
wherein the electronic device streams real-time 3D video with 360 degree freedom of eye motion for the user by switching between bandwidths based on the probability graph calculated.

18. The system of claim 17, wherein the electronic device is one of a wearable electronic device, a gaming console, a mobile device, and a 3D television.

19. The system of claim 17, wherein the probability graph is calculated by:
generating a first vector for each frame of the scene files of the unwrapped hemispherical representations of scenes for the left and right eye perspective views;
selecting two consecutive frames and generating a second vector therefrom including a direction of motion of the eyes of the user;
storing the second vector in a time-coded file for each frame of the two consecutive frames; and
transmitting motion vector data to a client application of the electronic device of the user.

20. The system of claim 19,
wherein the unwrapped hemispherical representations of scenes for the left and right eye perspective views are stored in first and second video files, respectively; and
wherein, if a disparity map of the first and second video files is available, a change in disparity between the two consecutive frames is included in calculating the probability graph.
